(19) United States
(12) Patent Application Publication
(10) Pub. No.: US 2002/0191346 A1
(43) Pub. Date: Dec. 19, 2002

(54) Voice coil motor

(76) Inventors: Youichi Oki, Sukumo-shi (JP); Katsuyoshi Masuda, Sukumo-shi (JP)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(21) Appl. No.: 10/169,280

(22) PCT Filed: Oct. 23, 2001
(86) PCT No.: PCT/JP01/09308

(30) Foreign Application Priority Data
Oct. 27, 2000 (JP) 2000-329427

(51) Int. Cl. G11B 5/55

(52) U.S. Cl. 360/264.7

(57) ABSTRACT

A VCM is provided which is used for the positioning drive of a magnetic head of a hard disk drive apparatus, is capable of preventing the attachment of dirt onto back yoke(s), and at the same time has a magnetic circuit, height of which can be lowered. Step parts 14a and 15a are formed on a base 14 and a cover 15, and magnets 3 and 3, which are placed on upper and lower sides of a magnetic action space, are fixed with glue respectively to the inner surface of said step parts 14a and 15a of the base 14 and the cover 15. A lower back yoke 12 and a upper back yoke 11 are placed respectively outside of the step parts 14a and 15a of the base 14 and the cover 15.

### TECHNICAL FIELD

The present invention relates to a voice coil motor (hereinafter, abbreviated as VCM) used in the positioning drive of a magnetic head in a hard disk drive apparatus, in particular relates to the structure of magnetic circuit thereof.

### BACKGROUND ART

In s VCM used in the positioning drive of a magnetic head of a hard disk drive apparatus, a planar coil is placed in a magnetic action space in which magnetic field is produced in a vertical direction, and by controlling the current flowing through the planar coil, this planar coil is driven in a horizontal direction by the interaction with the magnetic field.

The configuration of a magnetic circuit for producing a concentrated magnetic field in the magnetic action space in a conventional VCM will be explained with referring to FIG. 10. Part (a) of FIG. 10 is a cross-sectional view cut in a horizontal plane of a magnetic circuit of a conventional VCM, and part (b) is a cross-sectional view cut in a vertical plane. Hereupon, in parts (a) and (b) of FIG. 10, a planar coil placed in the magnetic action space is not shown for making explanation simple.

In parts (a) and (b) of FIG. 10, two magnets 3 and 3 placed at upper and lower sides produce a vertical magnetic field in the magnetic action space 10. And, in order to concentrate the magnetic field within the magnetic action space 10, a magnetic circuit for focusing the rear magnetic field of two magnets 3 and 3 placed at upper and lower sides is formed with an upper back yoke 1 and a lower back yoke 2, ends of which are connected with each other. This magnetic circuit is constructed by fixing both magnets 3 and 3 to upper and lower back yokes 1 and 2 respectively by gluing surfaces of the magnets, which are opposite to surfaces facing to the magnetic action space, to the yokes, superposing both end parts of upper and lower back yokes 1 and 2, and fixing them by screws which are not shown to a base 4 formed out of an aluminum alloy or the like.

This magnetic circuit is covered with a cover 5 which is formed out of an aluminum alloy or the like, and the cover is fixed to the base 4 with screws at several points of end parts of the cover 5. In such a manner, magnets 3 and 3 as well as both upper and lower back yokes 1 and 2 are stored inside the base 4 and the cover 5.

Hereupon, there is also such a VCM having a magnetic circuit , in which a single magnet is placed at the upper side, as is disclosed in Unexamined Patent Application Bulletin (Tokkai) Hei 7-78426.

In a hard disk apparatus, since components contained inside the base 4 and the cover 5 are precision components, it is required to pay attention in protecting those parts from various dirt (disposed gas, dust, dirt, corrosion). Therefore, the upper and lower back yokes 1 and 2 in the prior art were also coated by resin or the like so as to reduce the attachment of dirt. However, as for those parts such as back yoke comprising the magnetic circuit, there have been problems such that metallic dust particles were apt to attach thereto accompanied with the rotation or the like.

And as for the hard disk apparatus, it is necessary to lower the height thereof because of the miniaturization of personal computers and the information terminal devices into which the hard disk apparatus is installed. However, there was also a problem that the height of the total hard disk apparatus became to be high due to the structure of the hard disk apparatus of prior art, since the height of the VCM part became to be high because of the configuration wherein base, upper and lower back yokes, magnets and cover were overlapped in space.

It is the purpose of the present invention to propose a VCM, by which the attachment of dirt generated from inside is prevented, and at the same time, a hard disk apparatus having reduced height is realized.

### DISCLOSURE OF INVENTION

In order to solve the above-mentioned problems, a VCM of the present invention is characterized in having magnet(s) placed on upper and lower sides of a magnetic action space in which a planar coil is disposed, an upper back yoke and a lower back yoke forming a magnetic circuit to produce a concentrated magnetic field by the above-mentioned magnet(s) in the above-mentioned magnetic action space, and a case comprising a base and a cover which stores at least the above-mentioned magnet(s), the above-mentioned magnetic action space and the above-mentioned planar coil, wherein the above-mentioned upper back yoke and the above-mentioned lower back yoke are respectively placed outside of the above-mentioned cover and the above-mentioned base.

In accordance with this configuration, since the upper and lower back yokes are respectively placed outside of the case, attachment of dirt produced from inside of the case onto the upper and lower back yokes can be prevented. As a result, it is possible to realize a hard disk apparatus that can prevent troubles caused by the stain of the back yoke.

A VCM from another aspect of the present invention is characterized in having magnet(s) placed on upper and lower sides of a magnetic action space in which a planar coil is disposed, an upper back yoke and a lower back yoke forming a magnetic circuit to produce a concentrated magnetic field by the above-mentioned magnet(s) in the above-mentioned magnetic action space, and a case comprising a base and a cover which stores at least the above-mentioned magnet(s), the above-mentioned magnetic action space and the above-mentioned planar coil, wherein either the above-mentioned upper back yoke or the above-mentioned lower back yoke is placed outside of the above-mentioned cover and the above-mentioned base.

In accordance with this configuration a back yoke on which dirt is particularly apt to attach can be placed outside of the case. As a result, attachment of dirt produced from inside of the case onto the back yoke that is placed outside of the case can be prevented.

A VCM from further another aspect of the present invention is characterized in having magnet(s) placed on upper and lower sides of a magnetic action space in which a planar coil is disposed, an upper back yoke and a lower back yoke forming a magnetic circuit to produce a concentrated magnetic field by the above-mentioned magnet(s) in the above-mentioned magnetic action space, and a case comprising a base and a cover which stores the above-mentioned magnet(s), both the above-mentioned upper and lower back yokes, the above-mentioned magnetic action space and the above-mentioned planar coil, wherein forming the above-mentioned base and the above-mentioned cover out of magnetic material, thickness of both the above-mentioned upper and lower back yokes is made to be thinner by an amount of thickness corresponding to the thickness of the above-mentioned base or the above-mentioned cover.

In accordance with this configuration, by forming the base and the cover out of magnetic material, a part of the magnetic circuit can be constituted with the base and the cover. Thereby the thickness of those two back yokes can be made thinner by an amount of thickness corresponding to the thickness of the base and the cover. As a result, the height of the VCM can be lowered by an amount of reduced thickness of those two back yokes.

Furthermore, since the forming of the magnetic circuit is done at the same time when the case is formed by screwing up the base and the cover, assembly process of the VCM can be simplified.

In the VCM of this configuration, both of the upper and lower back yokes or either of the back yokes may be placed outside of the base and the cover. Thereby the height of the VCM can be made thin, and at the same time the attachment of dirt produced from inside of the case onto the back yoke(s) placed outside of the case can be prevented.

A VCM from further another aspect of the present invention is characterized in having magnet(s) placed on upper and lower sides of a magnetic action space in which a planar coil is disposed, and a case comprised of a base and a cover which are formed out of magnetic material respectively, stores the above-mentioned magnet(s), the above-mentioned magnetic action space and the above-mentioned planar coil, and forms a magnetic circuit to produce a concentrated magnetic field by the above-mentioned magnet(s) in the above-mentioned magnetic action space.

In accordance with this configuration, since the magnetic circuit is comprised of the base and the cover formed out of magnetic material, the back yoke becomes unnecessary. As a result, the configuration is simplified and the cost can be reduced, and at the same time, the height of the VCM can be further thinner.

In the VCM of the above-mentioned configuration either the base or the cover may be formed out of magnetic material. In this case, only the back yoke formed out of magnetic material becomes unnecessary.

A VCM from further another aspect of the present invention is a VCM characterized in that a magnet is placed on either of upper and lower sides of the magnetic action space in which the planar coil is disposed and it has a magnetic circuit of any one configuration of the VCMs having the above-mentioned configurations.

In accordance with this configuration even with the VCM having a magnet on either of an upper side and a lower side, it is possible to prevent of the dirt, to eliminate the back yoke, or to make the back yoke thinner.

The novel features of the invention will be hereinafter fully described and particularly pointed out in the appended claims, and the configuration and details of the invention, together with other objects and features thereof, will become better understood and appreciated by reference to the following detailed description when considered in conjunction with the accompanying drawings.

### BRIEF DESCRIPTION OF DRAWINGS

Part (a) of FIG. 1 is a cross-sectional view of a hard disk apparatus using a VCM of Embodiment 1 of the present invention, part (b) is a cross-sectional view of a magnetic circuit in the VCM of Embodiment 1 of the present invention.

FIG. 2 is a cross-sectional view of a magnetic circuit in a VCM of Embodiment 2 of the present invention.

FIG. 3 is a cross-sectional view of a magnetic circuit in a VCM of Embodiment 3 of the present invention.

FIG. 4 is a cross-sectional view of a magnetic circuit in a VCM of a modified Embodiment 3 of the present invention.

FIG. 5 is a cross-sectional view of a magnetic circuit in a VCM of a further modified Embodiment 3 of the present invention.

FIG. 6 is a cross-sectional view of a magnetic circuit in a VCM of Embodiment 4 of the present invention.

FIG. 7 is a cross-sectional view of a magnetic circuit in a VCM of a modified Embodiment 4 of the present invention.

FIG. 8 is a cross-sectional view of a magnetic circuit in a VCM of Embodiment 5 of the present invention, in which magnet 3 is made to be only one on the lower side, wherein part (a) is a magnetic circuit to which the configuration of Embodiment 1 is applied, part (b) is a magnetic circuit to which the configuration of Embodiment 2 is applied, and part (c) is a magnetic circuit to which the configuration of Embodiment 3 is applied.

Part (a) of FIG. 9 is a magnetic circuit to which the configuration of a modified Embodiment 3 is applied, part (b) is a magnetic circuit to which the configuration of a further modified Embodiment 3 is applied, part (c) is a magnetic circuit to which the configuration of Embodiment 4 is applied, and part (d) is a magnetic circuit to which the configuration of a modified Embodiment 4 is applied.

FIG. 10 is a cross-sectional view of a magnetic circuit in a conventional VCM.

It will be understood that all or part of the drawings are purely diagrammatic for illustrative purposes and do not necessarily present faithful depictions of the actual relative sizes or positions of the illustrated elements.

### BEST MODES FOR CARRYING OUT THE INVENTION

In the following, explanation of preferred embodiments of a VCM of the present invention will be given referring to attached drawings. Since the present invention is characterized in the configuration of a magnetic circuit of a VCM to be used in the positioning driving of a magnetic head of a hard disk drive unit, explanation is given using drawings in which a known planar coil of a VCM is omitted in the following explanation of embodiments.

<<Embodiment 1>>

Part (a) of FIG. 1 is a cross-sectional view of a hard disk apparatus using a VCM of Embodiment 1, part (b) is a cross-sectional view showing the configuration of a magnetic circuit of the VCM of Embodiment 1.

In part (a) of FIG. 1, a magnetic disk 21 is rotated by a spindle motor 13 fixed to a base 14 of a case, and information data are read out or written in with a magnetic head 17 along with this rotation. A carriage 16 is held with free of rotation on a pole planted on the base 14, a magnetic head 17 is fixed on one end of this carriage 16, and a planar coil 6 is fixed on the other end of the carriage 16.

In part (b) of FIG. 1, two magnets 3 and 3 are fixed to a space inside of a cover 15 and a base 14 which are formed out of an aluminum alloy or the like, and they are fixed with glue to the inside of step parts 15a and 14a having a convex shape projecting toward the magnetic action space 10 respectively. Furthermore, upper back yoke 11 and the lower back yoke 12 are fixed closely respectively to the outside of the step parts 14a and 15a made on the cover 15 and the base 14, thereby forming a magnetic circuit for producing a specified concentrated magnetic field in a magnetic action space 10 in which a planar coil 6 is inserted.

By controlling the current flow through the planar coil 6, making the carriage 16 rotate on the pole as the axis by the interaction of the magnetic field and making the magnetic head 17 move at high speed to a specified position, the positioning of the magnetic head is attained.

And in the direction perpendicular to the drawing plane of part (b) of FIG. 1, although they are not shown, both end parts of the upper back yoke 11 and the lower back yoke 12 are superposed in a similar manner as in the prior art and they are screwed up to the base 14 at an outside part of the cover 15.

As for the other mode of the configuration of the magnetic circuit of the upper and lower back yokes, at least one end part of the upper back yoke 11 or the lower back yoke 12 may be superposed, for example, at the backside place of the drawing plane. Furthermore, the upper back yoke and the lower back yoke may be united in a single body with a horseshoe-shape or a rectangular-shape.

In the VCM of this embodiment 1, the upper back yoke 11 and the lower back yoke 12 are placed outside of the cover 15 and the base 14 respectively. As a result, attachment of the dirt from the inside of the cover 15 onto both of back yokes 11 and 12 can be prevented.

<<Embodiment 2>>

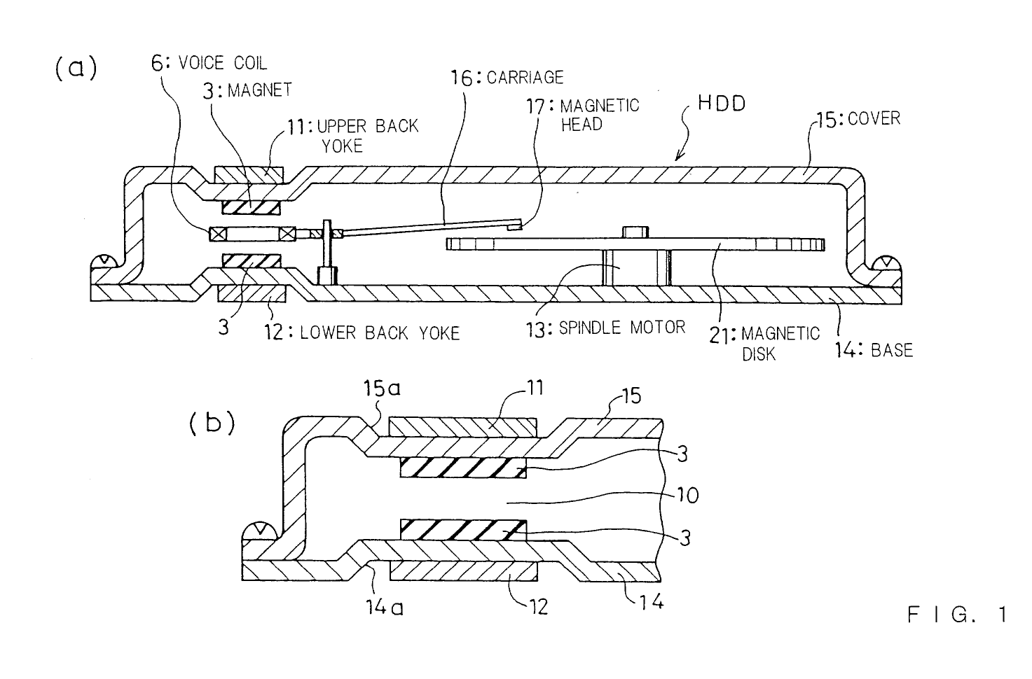

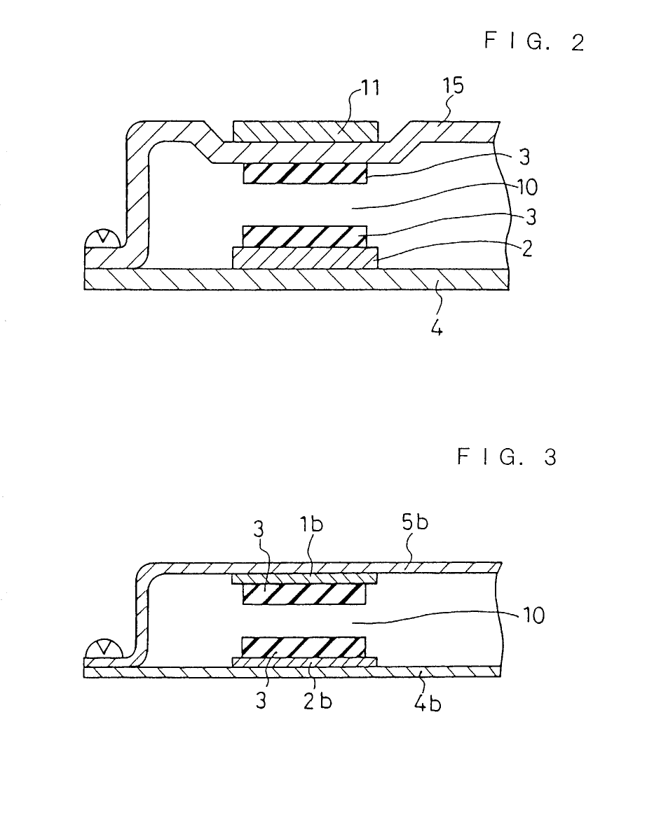

FIG. 2 is a cross-sectional view showing the configuration of a magnetic circuit in a VCM of Embodiment 2 of the present invention. The magnetic circuit in a VCM of Embodiment 2 is a magnetic circuit wherein only the back yoke, on which the dirt is apt to attach, is placed outside of the cover or the base. Therefore, the same numerals are given to the same parts as those parts of prior art or Embodiment 1 so as to simplify the explanation.

In FIG. 2 a magnet 3 placed on the upper side of the magnetic action space 10 is fixed with glue to the inside surface of a convex part of the cover 15 formed out of an aluminum alloy or the like having the convex step part 15a projecting toward the magnetic action space 10. On the other hand a lower side magnet 3 is fixed with glue to the lower back yoke 2 placed inside of a flat base 4. An upper back yoke 11 is placed closely on the outside of the step part 15a of the cover 15.

And in the direction perpendicular to the drawing plane of FIG. 2, both end parts of the lower back yoke 2 are drawn to the outside from the lower part of the cover 15. And in the direction perpendicular to the drawing plane not shown in the drawing, both end parts of the upper back yoke 11 and the lower back yoke 2 are superposed and are screwed up to the base 4 at an outside part of the cover 15 respectively.

Besides, similar to the Embodiment 1, a configuration may be made in which only one end part of the upper and lower back yokes is superposed.

In the VCM of this embodiment 2, the upper back yoke 11 is placed outside of the cover 15. As a result, for example, attachment of the dirt from the inside of the cover 15 onto the upper back yoke 11, to which dirt is apt to attach depending on the polarity of the magnetic pole, can be prevented.

<<Embodiment 3>>

FIG. 3 is a cross-sectional view showing a configuration of a magnetic circuit in a VCM of Embodiment 3 of the present invention. The magnetic circuit of the present Embodiment 3 is the one that the cover 5b and the base 4b are formed respectively out of magnetic material such as iron plate.

As shown in FIG. 3, by forming the cover 5b and the base 4b respectively out of magnetic material such as iron plate, the cover 5b and the base 4b respectively have a function of a yoke through which magnetic flux is led. Thereby the thickness of the upper back yoke 1b and the lower back yoke 2b can be made thinner respectively by an amount of thickness of the cover 5b and the base 4b. Furthermore, both side parts of the cover 5b are superposed on the base 4b and screwed up to form a magnetic circuit. As a result, in accordance with the magnetic circuit of Embodiment 3, height of the VCM can be lowered and at the same time the assembly process can be simplified because the forming of the magnetic circuit can be done simultaneously with the screw up of the case.

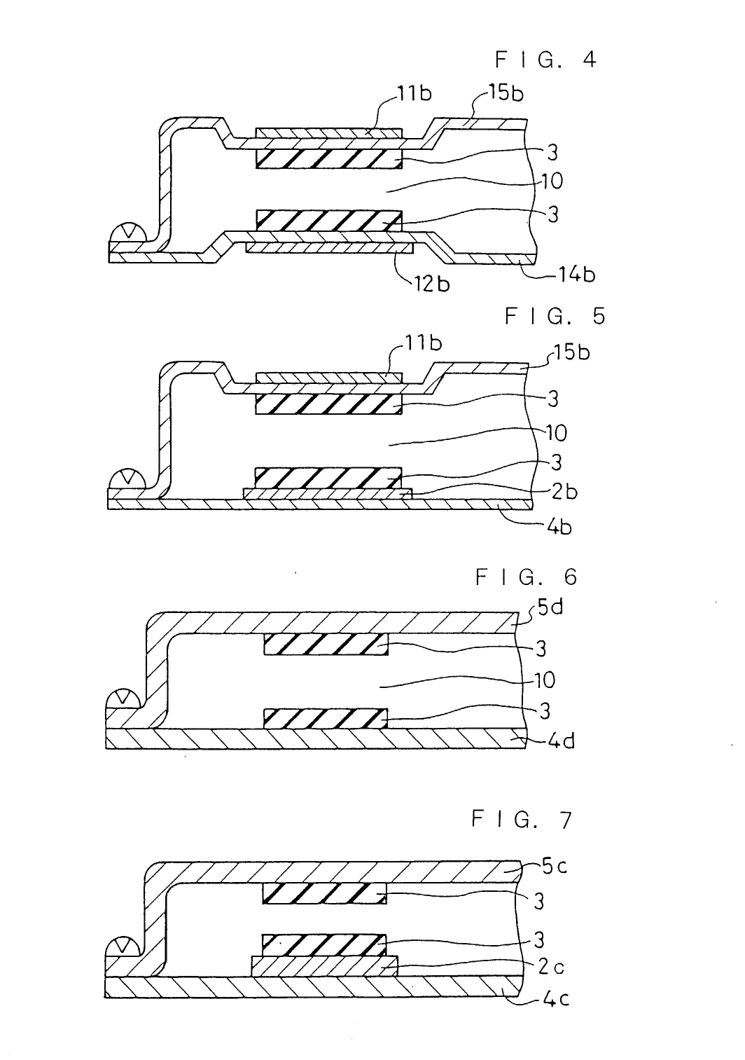

FIG. 4 is a cross-sectional view showing a modified example of the magnetic circuit in which the configuration of the magnetic circuit of this Embodiment 3 is applied to that of Embodiment 1.

As is shown in FIG. 4, by means of forming the cover 15b and the base 14b respectively out of magnetic material such as iron plate, the cover 15b and the base 14b respectively have a function of yoke through which magnetic flux is led. Thereby the thickness of the upper yoke 11b and the base 12b can be made thinner respectively by an amount of thickness of the cover 15b and the base 14b. Furthermore, any gap of the magnetic circuit due to non-magnetic material does not appear between the upper and lower back yokes 11b, 12b, which are placed outside of the cover 15b and the base 14b, and the magnets 3. As a result, in accordance with the magnetic circuit of this embodiment mode, attachment of the dirt from the inside of the case onto the upper and lower back yokes can be prevented, and moreover the height of the VCM can be made lower than the height of the VCM of Embodiment 1, and at the same time the efficiency of the magnetic circuit can be improved.

FIG. 5 is a cross-sectional view showing a modified example of the magnetic circuit to which the configuration of the magnetic circuit of Embodiment 3 is applied to that of Embodiment 2.

As is shown in FIG. 5, by forming the cover 15b and the base 4b out of magnetic material, thickness of the cover 15b and the base 4b can be made thinner by an amount of thickness of the cover 15b and the base 4b. As a result, in accordance with the magnetic circuit of this embodiment mode, attachment of the dirt from the inside of the case onto the upper back yoke 11b can be prevented, and moreover the height of the VCM can be made lower than the height of the VCM of Embodiment 2, and at the same time the efficiency of the magnetic circuit can be improved.

<<Embodiment 4>>

FIG. 6 is a cross-sectional view showing the configuration of a magnetic circuit in a VCM of Embodiment 4 of the present invention. The magnetic circuit of this Embodiment 4 is the one in which the cover 5c and the base 4c are formed respectively out of magnetic material such as iron plate having a thickness approximately equal to or thinner than that of conventional upper and lower back yokes. As is shown in FIG. 6, the cover 5c and the base 4c are formed respectively out of magnetic material such as iron plate having a thickness approximately equal to or thinner than that of conventional upper and lower back yokes to form a magnetic circuit. Thereby the upper and lower back yokes become unnecessary, they can be eliminated and at the same time, by superposing and screwing up the cover 5c and the base 4c at their end parts, the formation of the magnetic circuit can be done simultaneously with the formation of the case.

As a result, the thickness of the VCM can be made thinner, and at the same time the assembly process of the magnetic circuit can be simplified.

FIG. 7 is a cross-sectional view showing the configuration of a magnetic circuit of an embodiment modified from the magnetic circuit of the present Embodiment 4.

As is shown in FIG. 7, the magnetic circuit of this modified embodiment is the magnetic circuit formed by adding a lower back yoke 2c in the magnetic circuit of the present Embodiment 4. Since the cover 5c and the base 4c are both magnetic material, in case that the degree of magnetic flux concentration is low in the magnetic action space 10 when the thickness of the magnets 3 are thin, the degree of magnetic flux concentration can be improved owing to the presence of this back yoke 2c. Although lower back yoke is added in this example, similar effect can also be achieved by adding the upper back yoke. And, in this case, since a magnetic circuit is formed by the back yoke 2c and the cover 5c, material of the base may be non-magnetic material.

<<Embodiment 5>>

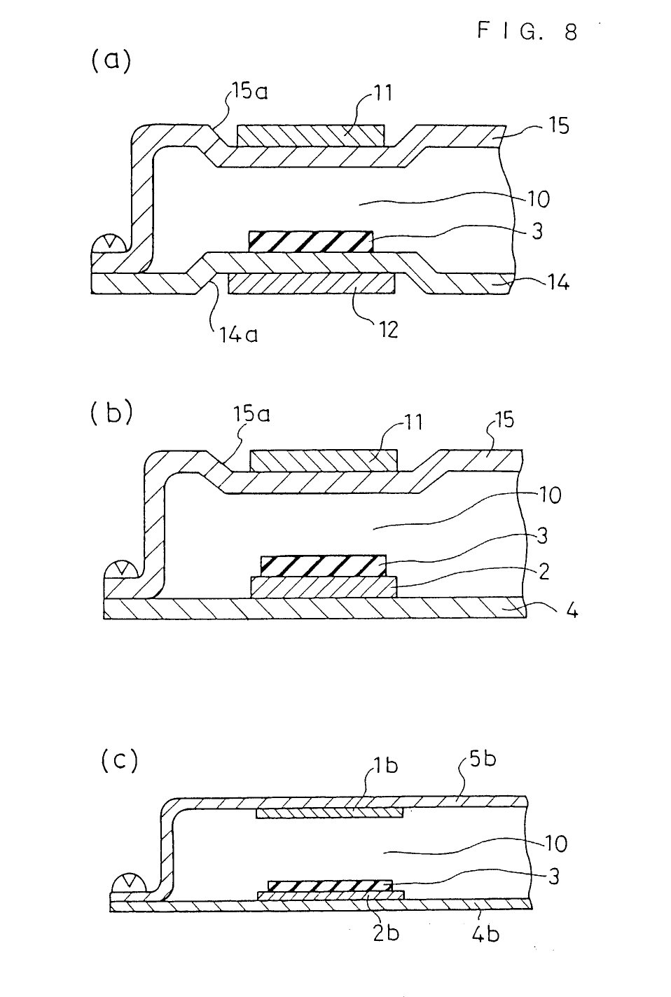

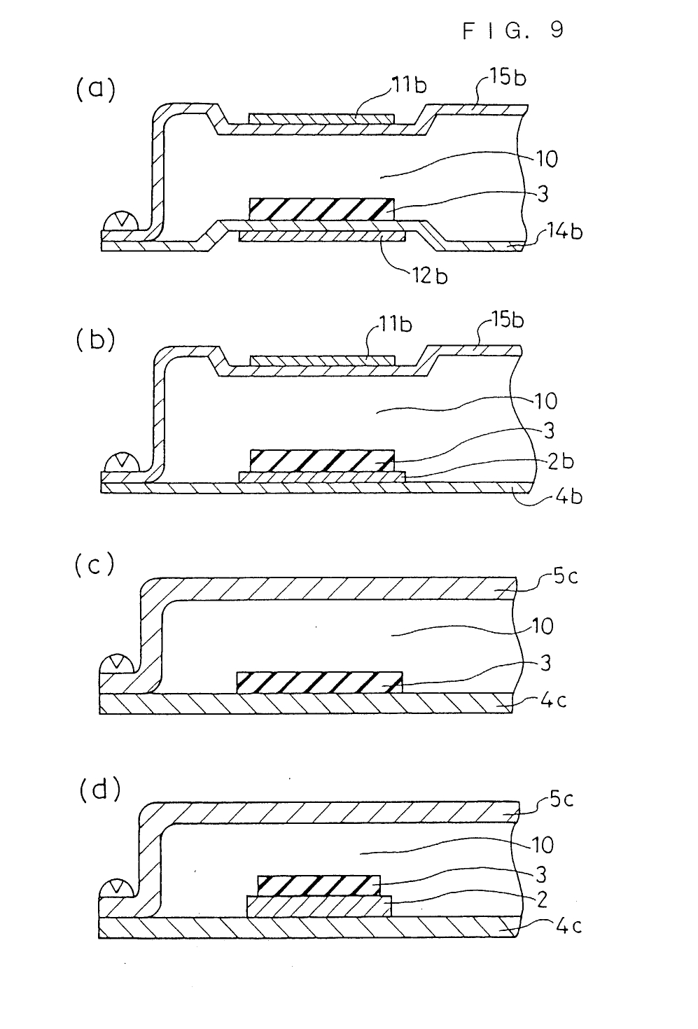

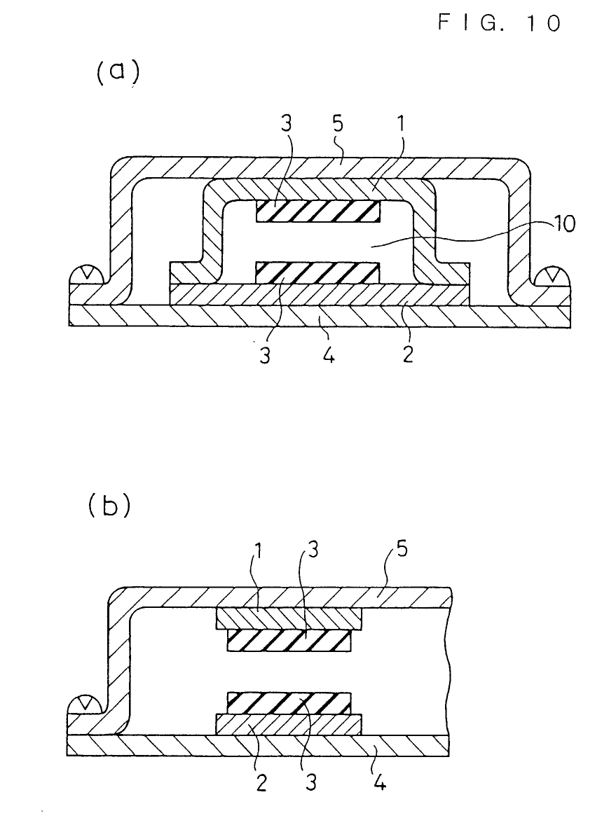

Parts (a)-(c) of FIG. 8 and parts (a)-(d) of FIG. 9 are cross-sectional views showing the configurations of magnetic circuits of various modified embodiments in VCM of the present Embodiment 5. As has been described in the prior art, a VCM in which a magnet is placed on either of upper and lower sides is also employed in practical use.

Magnetic circuits of these Embodiments 5 are ones in which the magnets 3 of the magnetic circuit of the Embodiments 1 to 4 are reduced to be a single magnet of the lower side. Accordingly, the same reference numerals are given to the same parts of Embodiments 1 to 4 and their repeated explanations are omitted.

A magnetic circuit shown in part (a) of FIG. 8 is the one in which the magnets 3 of the magnetic circuit of the Embodiments 1 are reduced to be a single magnet of the lower side. Namely, it is a magnetic circuit in which the upper back yoke 11 is place outside of the cover 15 and the lower back yoke is placed outside of the base 14, and its effect is the same as that of Embodiment 1.

A magnetic circuit shown in part (b) of FIG. 8 is the one in which the magnets 3 of the magnetic circuit of the Embodiments 2 are reduced to be a single magnet of the lower side. Namely, it is a magnetic circuit in which only the upper back yoke 11 is placed outside of the cover 15, and its effect is the same as that of Embodiment 2.

A magnetic circuit shown in part (c) of FIG. 8 is the one in which the magnets 3 of the magnetic circuit of the Embodiment 3 are reduced to be a single magnet of the lower side. Namely, it is a magnetic circuit in which the thickness of the upper back yoke 1b and the lower back yoke 2b is made thinner and they are placed inside of the base 4b and the cover 5b formed out of magnetic material, and its effect is the same as that of Embodiment 3.

A magnetic circuit shown in part (a) of FIG. 9 is the one in which the magnets 3 of the magnetic circuit of the modified embodiment mode of Embodiments 3 are reduced to be a single magnet of the lower side. Namely, it is a magnetic circuit in which the thickness of the upper back yoke 11b and the lower back yoke 12b is made to be thin and they are placed outside of the base 14b and the cover 15b which are formed out of magnetic material, and its effect is the same as that of other embodiment modes of Embodiment 3.

A magnetic circuit shown in part (b) of FIG. 9 is the one in which the magnets 3 of the magnetic circuit of the further modified embodiment mode of Embodiment 3 are reduced to be a single magnet of the lower side. Namely, it is a magnetic circuit in which the thickness of the upper back yoke 11b and the lower back yoke 2b are made thin and the upper back 11b is placed outside of the cover 15b, and its effect is the same as that of the further modified embodiment mode of Embodiment 3.

A magnetic circuit shown in part (c) of FIG. 9 is the one in which the magnets 3 of the magnetic circuit of Embodiment 4 are reduced to be a single magnet of the lower side. Namely, it is a magnetic circuit in which the cover 5c and the base 4c are formed out of magnetic material having a thickness approximately equal to or thinner than that of the back yoke, and its effect is the same as that of Embodiment 4.

A magnetic circuit shown in part (d) of FIG. 9 is the one in which the magnets 3 of the magnetic circuit of the modified embodiment mode of Embodiment 4 are reduced to be a single magnet of the lower side. Namely, it is a magnetic circuit in which the cover 5c is formed out of magnetic material having a thickness approximately equal to or thinner than that of the back yoke, it is a magnetic circuit from which the upper back yoke is eliminated, and its effect is the same as that of the modified embodiment mode of Embodiment 4.

In addition, in the magnetic circuit of the above-mentioned Embodiment 5, although the explanation has been given on the magnetic circuit in which magnets 3 are reduced to be a single one of the lower side, it is needless to mention that it can also be applied to the magnetic circuit in which magnets are reduced to-be a single one of the upper side.

And, in the Embodiments described above, although the explanation has been given on the one in which the base was a flat plate and the cover was made to be a box shape, both of them, for example, may be made to be a box shape of substantially the same shape.

As has been above-explained in detail in many embodiments, in accordance with those VCMs of the present invention, the attachment of the dirt onto the back yoke from the inside of the case can be prevented by placing the back yokes outside of the base and the cover in their magnetic circuits.

And, by forming the cover and the base out of magnetic material, the back yokes can be eliminated or made thinner, the height of the VCM can be lowered and at the same time the efficiency of the magnetic circuit can be improved.

Although the invention has been described in some detail dealing with the preferred embodiments, the configuration details of any of the preferred embodiments disclosed herein may be changed or modified, and any changes in the combination or order of elements thereof can be accomplished without departing from the spirit and scope of the invention as set forth in the appended claims

Industrial Applicability

The VCM in accordance with the present invention is useful for a VCM for a hard disk drive.

1. A voice coil motor characterized in having
magnet(s) placed at least on one side of upper and lower sides of a magnetic action space in which a planar coil is disposed,
an upper back yoke and a lower back yoke forming a magnetic circuit to produce a concentrated magnetic field by said magnet(s) in said magnetic action space, and
a case comprising a base and a cover which stores at least said magnet(s), said magnetic action space and said planar coil, wherein
said upper back yoke and said lower back yoke are respectively placed outside of said cover and said base.

2. A voice coil motor characterized in having
magnet(s) placed at least on one side of upper and lower sides of a magnetic action space in which a planar coil is disposed,
an upper back yoke and a lower back yoke forming a magnetic circuit to produce a concentrated magnetic field by said magnet(s) in said magnetic action space, and
a case comprising a base and a cover which stores at least said magnet(s), said magnetic action space and said planar coil, wherein
either said upper back yoke or said lower back yoke is placed outside of said cover and said base.

3. A voice coil motor characterized in having
magnet(s) placed at least on one side of upper and lower sides of a magnetic action space in which a planar coil is disposed,
an upper back yoke and a lower back yoke forming a magnetic circuit to produce a concentrated magnetic field by said magnet(s) in said magnetic action space, and
a case comprising a base and a cover which stores said magnet(s), both said upper and lower back yokes, said magnetic action space and said planar coil, wherein
forming at least one of said base and said cover out of magnetic material, thickness of the back yoke on the side of said base or said cover, which is formed out of magnetic material, is made to be thinner by an amount of thickness corresponding to the thickness of said base or said cover.

4. A voice coil motor stated in claim 1 or claim 2 characterized in that, forming at least one of said base and said cover out of magnetic material, thickness of the back yoke on the side of said base or said cover, which is formed out of magnetic material, is made to be thinner by an amount of thickness corresponding to the thickness of said base or said cover.

5. A voice coil motor stated in claim 1 or claim 2 characterized in that, forming at least one of said base or said cover out of magnetic material, back yoke(s) placed outside of said base or said cover, which is (are) formed said out of said magnetic material, is (are) eliminated.

6. A voice coil motor stated in claim 2 or claim 3 characterized in that, forming at least one of said base or said cover out of magnetic material, back yoke(s) placed inside of said base or said cover, which is formed out of said magnetic material, is (are) eliminated.

7. A voice coil motor characterized in having
magnet(s) placed at least on one side of upper and lower sides of a magnetic action space in which a planar coil is disposed, and
a case, which is formed out of magnetic material, forms a magnetic circuit to produce a concentrated magnetic field by said magnet(s) in said magnetic action space, and is comprised of a base and a cover which stores said magnet(s), said magnetic action space and said planar coil.

8. A voice coil motor stated in claim 6 characterized in that a back yoke is further placed on either said base or said cover.
